(19) United States
(12) Patent Application Publication
(10) Pub. No.: US 2005/0247895 A1
(43) Pub. Date: Nov. 10, 2005

(54) Surface inspecting apparatus and surface inspecting method

(75) Inventors: Moritoshi Ando, Kawasaki (JP); Satoru Sakai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/116,175

(22) Filed: Apr. 28, 2005

(30) Foreign Application Priority Data
May 10, 2004 (JP) 2004-140290

(51) Int. Cl. G01N 21/86

(52) U.S. Cl. 250/559.44

(57) ABSTRACT

A surface inspecting apparatus that inspects a surface of a material based on an intensity of a reflected light from the surface includes an illuminating unit that illuminates a light on the surface; and a detecting unit that detects the intensity of the reflected light from the surface. The light has an intensity distribution in which an intensity of the light is higher approaching the surface.

### BACKGROUND OF THE INVENTION

1) Field of the Invention

The present invention relates to a technology for inspecting a surface of a material based -on an intensity of reflected light on the surface.

2) Description of the Related Art

A conventional plasma display that emits light by applying voltage on a high-pressure gas such as neon and xenon is manufactured by machining separately two plate components and bonding the two plate components together. As shown in FIG. 12, on the surfaces that are bonded together, dents and bulges of sub-micron level exist even for components that are finely processed. When a height of the dents and bulges reach few microns, the bonding is not perfect, and as a result, a defect is formed.

Even if there are no dents and bulges of few microns on a surface of one of the components, when this component is bonded on other-component that has dents and bulges of few microns, both the components are wasted and there is a decrease in the yield. Therefore, it is extremely important to inspect the surface of the component before a bonding process.

For this reason, a quality inspecting apparatus that illuminates light on a surface under inspection (hereinafter, “surface”), and judges quality of the surface based on a distribution of intensity of reflected light, has been proposed (see, for example, Japanese Patent Application Laid-open Publication No. 2000-55826 and Japanese Patent Application Laid-open Publication No. 2002-310917). FIG. 13 is a schematic for illustrating a reflection of light when there is a bulge 2 on a surface 1; and FIG. 14 is a schematic for illustrating a conventional method of inspecting the surface.

As shown in FIG. 13, when the bulge 2 is there on the surface, at a front portion of the bulge 2, light is reflected further towards upper side as compared to that reflected at a flat surface 1, and at a rear portion of the bulge 2, the light is reflected further towards lower side as compared to that reflected at the flat surface 1. Thus, if the bulge 2 is there on the surface, a direction of advancement of the reflected light is spread.

Therefore, as shown in FIG. 14, when illuminating light 4 is allowed to be incident on the surface and reflected light is allowed to be incident on a focusing lens 7 via an aperture 6, and focused, and when intensity of reflected light is detected by a photodetector 8, if the surface is flat, the intensity of light is high and if the surface is a bulge 2, the intensity of light is low.

Similarly, if there is a dent on the surface, the intensity of light detected by the photodetector 8 is low. Thus, an observation of the intensity of the reflected light that is detected by the photodetector 8 makes it possible to judge whether there are dents and bulges on the surface.

Furthermore, in a case where there are dents and bulges on the surface and a case where there are no dents and bulges on the surface, for increasing a difference in the intensity of the reflected light and to detect a minute defect with ease, the light has been illuminated from a low angle on the surface.

FIG. 15 is a graph of a relationship between an incidence angle and a reflectance of light on an insulating material such as glass, ceramics, and plastic. As shown in FIG. 15, if the incidence angle becomes 80 degrees, in other words, if an illumination angle becomes 10 degrees, there is a sudden increase in the reflectance of light.

However, in the conventional technologies proposed in the Japanese Patent Application Laid-open Publication No. 2000-55826 and 2002-310917, although it is possible to inspect a presence of the dents and the bulges on the surface be inspected, it is not possible to judge whether it is a bulge or a dent, and a detailed analysis of a surface condition is not possible.

In other words, in a manufacturing process of the plasma display, when a defect on the surface is found, it is very important to figure out the condition of the surface in detail to find a cause of a problem and a method to solve the problem.

### SUMMARY OF THE INVENTION

It is an object of the present invention to solve at least the above problems in the conventional technology.

A surface inspecting apparatus according to one aspect of the present invention, which inspects a surface of a material based on an intensity of a reflected light from the surface, includes an illuminating unit that illuminates a light on the surface; and a detecting unit that detects the intensity of the reflected light from the surface. The light has an intensity distribution in which an intensity of the light is higher approaching the surface.

A method according to another aspect of the present invention, which is for inspecting a surface of a material based on an intensity of a reflected light from the surface, includes illuminating a light on the surface; and detecting the intensity of the reflected light from the surface. The light has an intensity distribution in which an intensity of the light is higher approaching the surface.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating characteristics of illumination light according to the present invention;

FIG. 2 is a schematic for illustrating a concept of a surface inspecting process;

FIG. 3 is a graph of a relationship between an intensity of reflected light and a detection angle;

FIG. 4 is a schematic of a surface inspecting apparatus according to the present invention;

FIG. 5 is a schematic for illustrating a detailed structure of an optical system according to a first embodiment of the present invention;

FIG. 6 is a schematic for illustrating an intensity-image of the reflected light detected by the surface inspecting apparatus;

FIG. 7 is a schematic for illustrating a process of detecting local dents and bulges;

FIG. 8 is a schematic for illustrating a process of calculating heights of the dent and the bulge;

FIG. 9 is a flowchart of a process procedure for a surface inspecting method;

FIG. 10 is a schematic for illustrating a detailed structure of an optical system according to a second embodiment of the present invention;

FIG. 11 is a cross section of a variable-transmittance filter shown in FIG. 10;

FIG. 12 is a schematic for illustrating a defect on a surface under inspection;

FIG. 13 is a schematic for illustrating a reflection of light when there is a bulge on the surface under inspection;

FIG. 14 is a schematic for illustrating a conventional quality inspecting method; and

FIG. 15 is a graph of a relationship between an incidence angle and a reflectance on an insulating material.

### DETAILED DESCRIPTION

Exemplary embodiments of a surface inspecting apparatus and a surface inspecting method according to the present invention are explained in detail below with reference to the accompanying drawings.

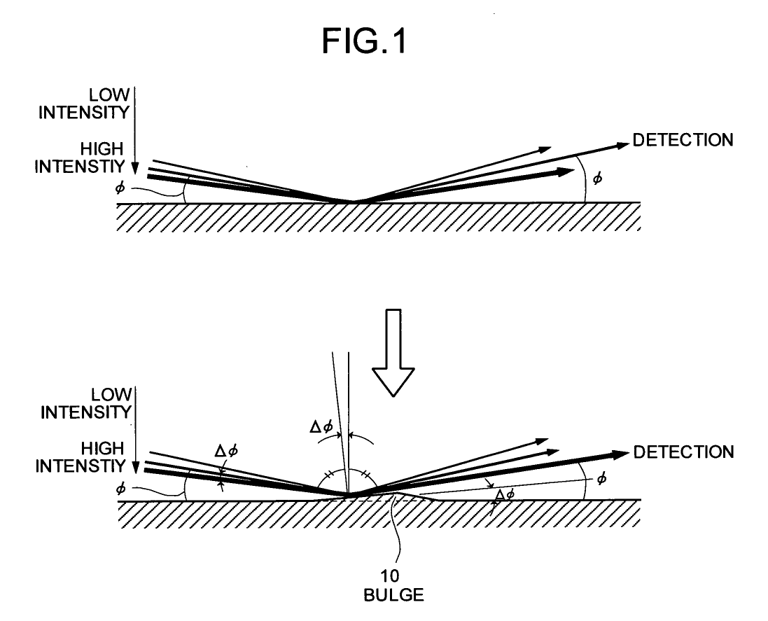

FIG. 1 is a schematic for illustrating characteristics of illumination light according to the present invention. In the surface inspecting process, light is illuminated on a surface and an intensity of reflected light from the surface is detected by a device such as a charge-coupled device (CCD) camera.

However, in the surface inspecting process, rather than a light of uniform intensity allowed to be illuminated on the surface, a light that has a distribution of intensity of light as high as an intensity of a side of the surface is allowed to be illuminated. In FIG. 1, each arrow shows a path of light and thickness of the arrows is directly proportional to the intensity of the light.

If the surface is flat, the light is illuminated on the surface at an angle 4. Light that is mirror reflected from the surface at the angle 4 reaches the CCD camera that is fixed at a position, and is detected.

However, if there is a bulge on the surface, the light with the high intensity that is illuminated at a low angle on the surface reaches the CCD camera, and is detected. Whereas, if there is a dent on the surface, the light with high intensity that is illuminated at a greater angle on the surface reaches the CCD camera, and is detected.

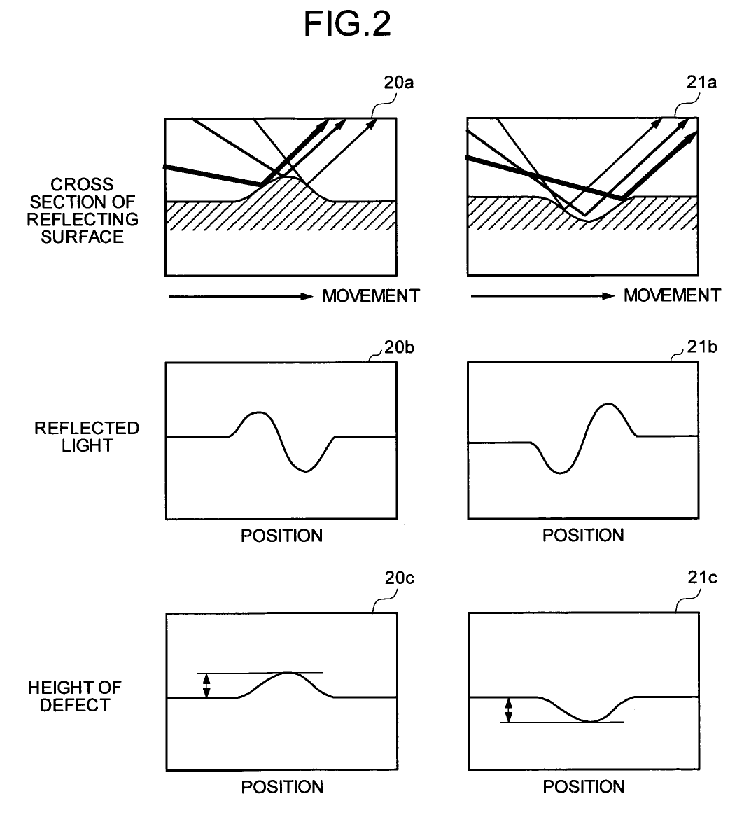

FIG. 2 is a schematic for illustrating a concept of a surface inspecting process. When there is a bulge on the surface, as shown in a reflecting cross-section 20a, if the light is illuminated while moving the surface towards a right direction in the diagram, at a front portion of the bulge, as compared to a case where the surface is flat, the light is reflected further upward. Therefore, the light having high intensity that is illuminated at a low angle reaches the CCD camera and is detected.

On the other hand, at a rear portion of the bulge, as compared to the case where the surface is flat, the light is reflected downward. Therefore, the light having low intensity that is illuminated at a greater angle reaches the CCD camera, and is detected.

Therefore, when there is a bulge on the surface, an intensity distribution, as shown in an intensity of reflected light 20b, is detected. Furthermore, a relationship between the intensity of reflected light and an angle of reflection of light is found in advance and a height of defect 20c is calculated from information about the angle of reflection.

When there is a dent on the surface, as shown in-the reflecting cross-section 21a, if the light is illuminated while moving the surface towards a right direction in the diagram, at a rear portion of the dent, as compared to the case where the surface is flat, the light is reflected further downward. Therefore, the light having low intensity that is illuminated at the greater angle reaches the CCD camera and is detected.

On the other hand, at a rear portion of the dent, as compared to the case where the surface is flat, the light is reflected upwards. Therefore, the light having high intensity that is illuminated at a smaller angle reaches the CCD camera and is detected.

Therefore, when there is a dent on the surface, an intensity distribution, as shown in the intensity of reflected light 21b, is detected. Thus, in both the cases of a bulge and a dent on the surface, a phase of the intensity of reflected light is reversed. Further, the height of defect 21c is calculated from the relationship between the intensity of reflected light and the angle of reflection of light.

As shown in FIG. 1, if the light is allowed to be illuminated on the surface at a low angle, when there is a bulge on the surface, light that has a small angle of illumination, in other words, light that has a big incidence angle, is detected. For the light having the big incidence angle, as shown in FIG. 15, since the reflectance of light becomes big, the intensity of light that is detected is even higher.

On the other hand, when there is a dent on the surface, if the light as shown in FIG. 1 is let to be illuminated at a low angle on the surface, it becomes a light having a bigger illumination angle, in other words, a light having a small incidence angle. For the light having the small incidence angle, as shown in FIG. 15, since the reflectance of light becomes small, the intensity of light that is detected is even lower.

Thus, by allowing the light that has the distribution of intensity as high as that of the side of the surface to be illuminated at a low angle, there is a big change in the intensity of the reflected light according to the dents and bulges on the surface. This enables to detect easily the minute dents and bulges on the surface and to detect in detail the defect of the dent and the bulge. It is desirable that the angle of illumination of the light is in a range of 5 degrees to 20 degrees.

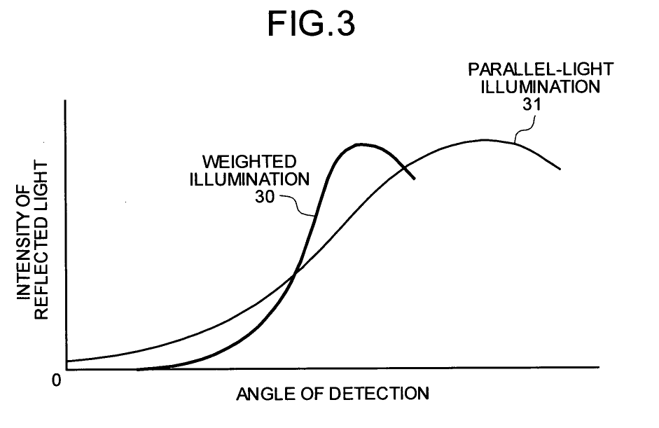

FIG. 3 is a graph of a relationship between an intensity of reflected light and a detection angle. The detection angle is an angle the reflected light makes with the surface. As shown in FIG. 3, if the light is illuminated by a weighted illuminating 30 for which the intensity is as high as that of the side of the surface, as compared to a case where the light is illuminated by a parallel light illuminating 31 that has a uniform intensity, the change in the intensity of the reflected light for the detection angle is big and even a small change in the detection angle can be detected. When the surface inspecting process based on the method mentioned above, was performed, a change in the detection angle of 1/10,000 rad could be read.

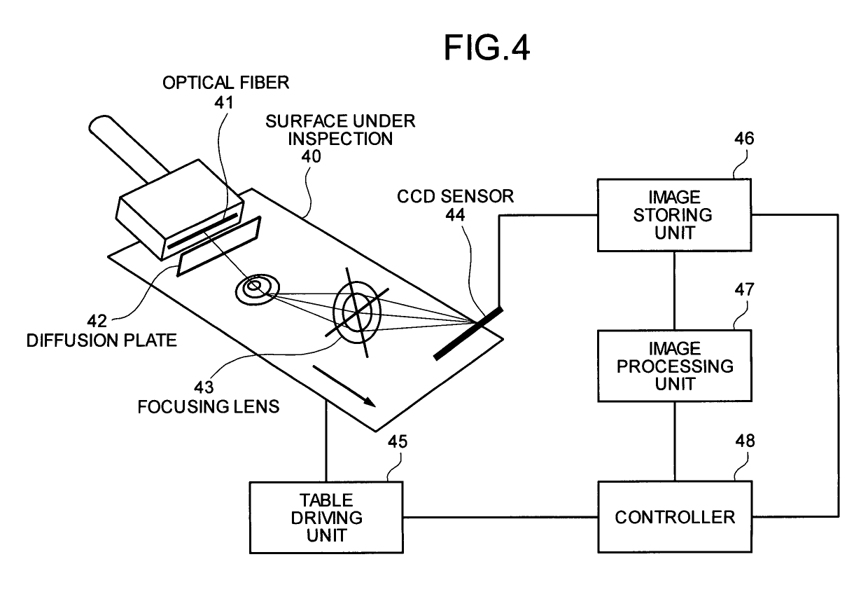

FIG. 4 is a schematic of a surface inspecting apparatus according to the present invention. The surface inspecting apparatus includes an optical fiber 41, a diffusion plate 42, a focusing lens 43, a CCD sensor 44, a table drive 45, an image storage 46, an image processor 47, and a controller 48.

The optical fiber 41 is a fiber bundle that is formed in the form of a line that illuminates light on a surface 40 under inspection (hereinafter, “surface 40”). The optical fiber 41 is disposed such that a center of the line is parallel to the surface 40. Therefore, light illuminated from the optical fiber 41 is spread in a space with some directionality with respect to a direction orthogonal to a center of the line. However, there is no change in the amount of light in a direction along the center of the line.

A lamp such as a halogen lamp, a metal-halide lamp, and a xenon lamp is disposed at one end of the optical fiber 41. By using such an optical fiber 41, a light having high luminescence as compared to that from a light source such as a fluorescent lamp can be illuminated over a wide range of about 300 mm.

The diffusion plate 42 causes to diffuse the light illuminated from the optical fiber 41. By passing of light illuminated from the optical fiber 41 through the diffusion plate 42, the light that is illuminated in the space with some directionality by the optical fiber 41 is diffused further and light equivalent to that illuminated from a light source having a wide area of illumination can be illuminated on the surface 40.

The focusing lens 43 focuses reflected light by the surface 40. The CCD sensor 44 is a line CCD sensor that receives the reflected light that is focused by the focusing lens 43, and detects the intensity of the reflected light.

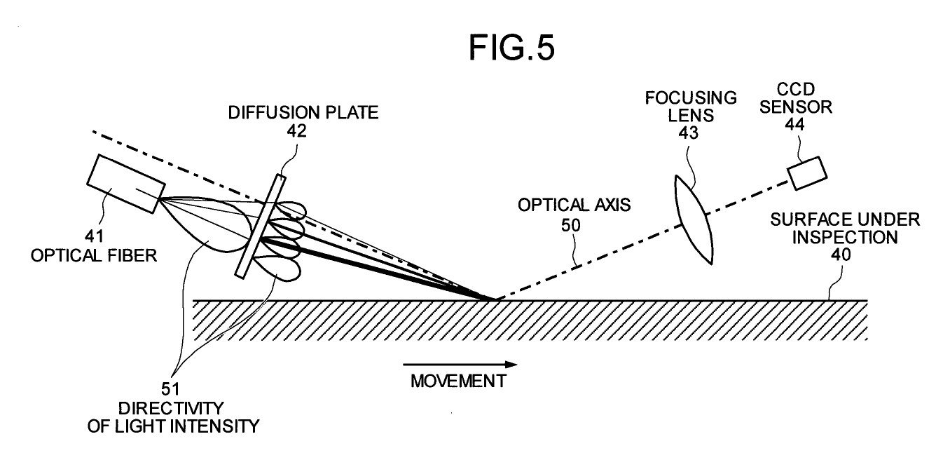

FIG. 5 is a schematic for illustrating a detailed structure of an optical system according to a first embodiment of the present invention. In the optical system, the optical sensor is disposed such that a center of the optical fiber 41 is at a position that is few millimeters away towards the side of the surface 40, from an optical axis 50 when the light radiated is mirror reflected from the surface 40 and reaches the CCD sensor 44.

The diffusion plate 42 is disposed at a position that is two to three centimeters away from the optical fiber so that the light emitted from the optical fiber passes through the diffusion plate 42. Directional characteristic 51 of light intensity as high as that of the light illuminated from the light illuminating source on the side of the surface 40, is realized as well as light equivalent to that illuminated from the light source having wide area of illumination, is illuminated.

Referring back to FIG. 4 the table drive 45 drives a table on which a component that includes the surface 40 and moves the surface 40 with respect to the optical system that detects the reflected light.

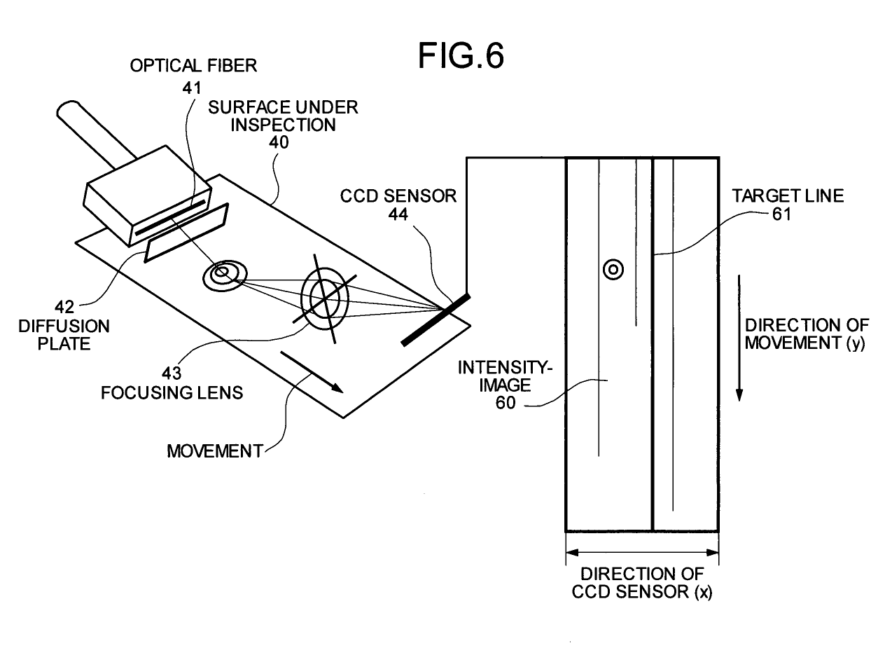

The image storage 46 stores information of intensity of the reflected light that is detected by the CCD sensor 44 as an intensity-image in a storage device such as a hard-disc unit, according to the movement of the surface 40. FIG. 6 is a schematic for illustrating an intensity-image of the reflected light detected by the surface inspecting apparatus.

The CCD sensor 44 detects the intensity of the reflected light while moving the surface 40 by the table drive 45, with respect to the optical system. The image storage 46 stores an intensity distribution of the reflected light that is detected by the CCD sensor 44 as an intensity-image 60.

In this case, number of pixels in an x direction of the image is determined according to number of pixels of the CCD sensor 44 (for example, 4096 pixels) and number of pixels in a y direction of the image is determined according to a distance moved. In the intensity-image 60, a portion with a high intensity is shown by a dark color (high gradation value) and a portion with a low intensity is shown by a light color (low gradation value).

Referring back to FIG. 4, the image processor 47, based on the intensity-image 60 stored in the image storage 46, calculates a height of the bulge and the dent on the surface 40 for each target line 61 shown in FIG. 6. The image processor 47 eliminates an effect of overall change in the surface 40 that is caused by factors such as a distortion in a supporting block, and calculates the height of the local dents and bulges.

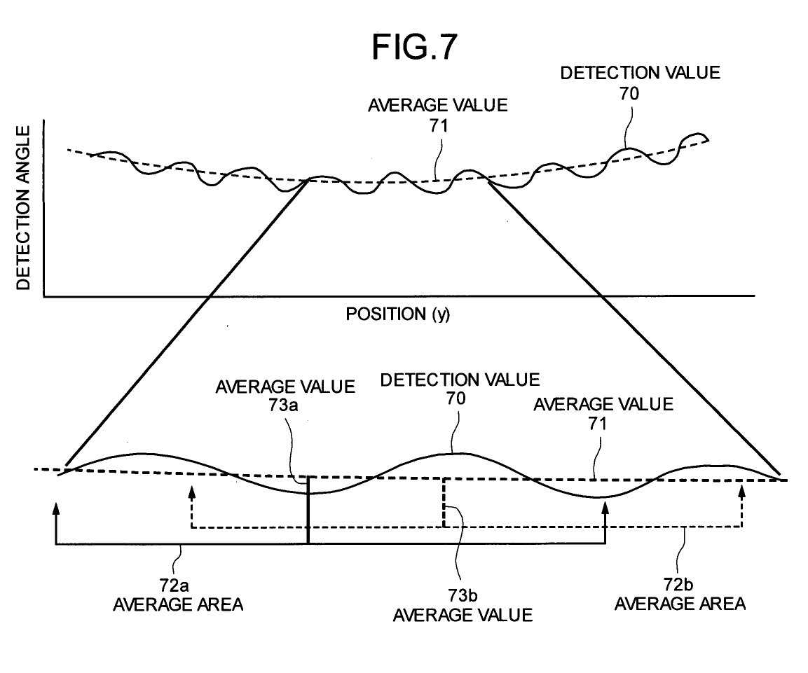

FIG. 7 is a schematic for illustrating a process of detecting local dents and bulges. A detection angle shown in FIG. 7 is a value that is converted from the intensity of reflected light based on the relationship between the intensity of reflected light and the detection angle shown in FIG. 3.

The image processor 47 calculates an average value 71 of the detection angle from a detected value 70. For each point on the target line 61 shown in FIG. 6, the image processor 47 sets average areas 72a and 72b with each point as a center. It is desirable that a width of the average areas 72a and 72b is about twice to three times of a cycle of increase and decrease in the detection angle.

Then, the image processor 47 calculates average values 73a and 73b of the detected value 70 that are included in the average areas 72a and 72b, and lets these average values 73a and 73b to be an average value 71 corresponding to the center of the average areas 72a and 72b. By calculating a difference between the average value 71 and the detected value 70, it is possible to calculate the detection angle of the reflected light in which the effect of the overall change is eliminated.

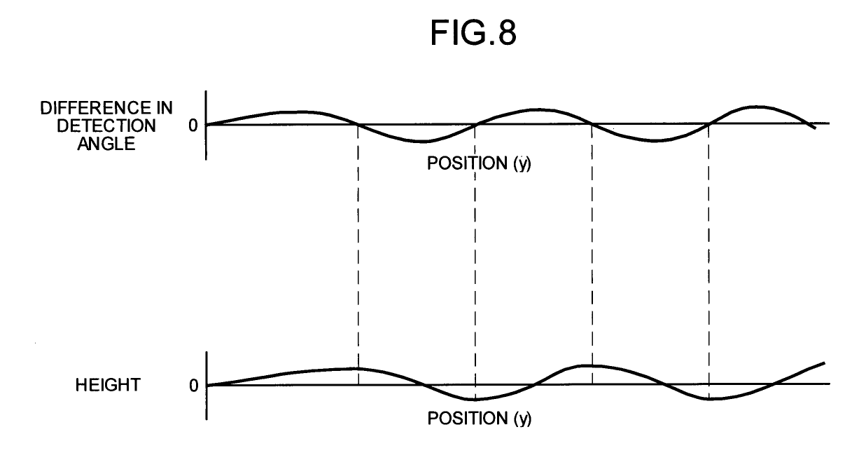

FIG. 8 is a schematic for illustrating a process of calculating heights of the dent and the bulge based on the difference in the detection angle that is obtained according to the method described referring to FIG. 7. If a difference in the angles of detection for each point shown in FIG. 8 is let to be Δφ and if a horizontal resolution of the direction of movement (y direction) of the surface 40 shown in FIG. 6 is let to be r, the difference Δφ in the detection angle for each point indicates an angle of inclination of the bulge or the dent. Therefore, it is possible to calculate the height h(a) of the bulge or the dent at a position a by the following approximate integral expression.
h(a)=ΣΔφ·r
where Σ means that for each point that is included in a position up to a position y=a from a position y=0 where h is 0, a product Δφ·r of the detection angle Δφ and the horizontal resolution r are summed up. Thus, as shown in FIG. 8, the height of the bulge or the dent can be calculated. The controller 48 moves the surface 40 by controlling table drive 45. The controller 48 also stores the intensity-image of the reflected light and calculates the height of the dents and bulges on the surface 40 by controlling the image storage 46 and the image processor 47.

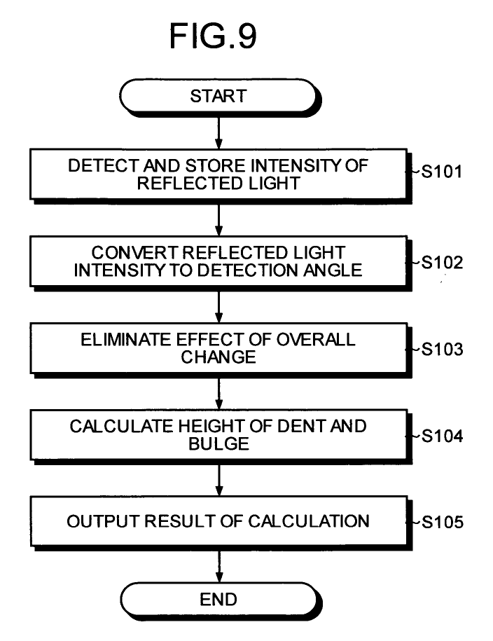

FIG. 9 is a flowchart of a process procedure for a surface inspecting method. The CCD sensor 44 of the surface inspecting apparatus detects the intensity of reflected light upon illuminating light on the surface 40 for inspecting by the optical fiber 41 and the diffusion plate 42, and the image storage 46 stores the intensity of reflected light as a reflected-light intensity-image (step S101).

Then, the image processor 47 converts a value of the intensity of the reflected light to the detection angle (step S102). Further, the image processor 47 calculates an average value of the detection angle, and by calculating a difference between the average value and the detection angle eliminates the effect of the overall change in the surface (step S103).

Further, the image processor 47 calculates the height of the dent and the bulge based on the detection angle for which the effect of the overall change is eliminated (step S104). The image processor 47 outputs the result of the calculation (step S105) and terminates the surface inspecting process.

According to the first embodiment, the optical fiber 41 and the diffusion plate 42 are let to illuminate on the surface 40 light that has the distribution of intensity of light as high as that on the side of the surface 40, and the CCD sensor 44 is let to detect the intensity of reflected light by the surface 40. Therefore, it is possible to change substantially the intensity of the reflected light according to the dents and bulges on the surface 40 and to detect in detail the defect on the surface 40.

Furthermore, according to the first embodiment, the optical fiber 41 and the diffusion plate 42 are let to illuminate on the surface 40 light such that an angle of the optical axis of the light illuminated with the surface 40 is in a range of 5 degrees to 20 degrees. Therefore, it is possible to change substantially the intensity of the reflected light according to the dents and bulges on the surface 40 and to detect in detail the defect on the surface 40.

Moreover, according to the first embodiment, the center of the light source of the optical fiber 41 is disposed at a position towards the side of the surface 40, away from the optical axis of the light that is detected upon specular reflection at the flat surface 40, and the diffusion plate 42 is disposed at a position away from the light source so that the light emitted from the light source passes through the diffusion plate. By using the optical system with the optical fiber 41 and the diffusion plate 42 disposed in such positions, the light that has the distribution of intensity of light as high as that on the side of the surface 40 is let to be illuminated on the surface 40. This enables to create efficiently the light illuminated that has the distribution of intensity of light as high as that on the side of the surface 40.

The distance between the light source of the optical fiber 41 and the diffusion plate 42 is let to be in the range of 2 cm to 3 cm. This enables to diffuse appropriately the light emitted from the light source.

The image processor 47 is let to calculate the height of the dent or the bulge on the surface 40 based on the relationship between the intensity of the reflected light that is detected and the angle of the reflected light from the surface 40. Therefore, by calculating the height, it is possible to detect in detail the defect on the surface 40.

Furthermore, according to the first embodiment, the image processor 47 is let to calculate the difference between the detected value 70 of the angle of the reflected light with the surface 40 and the average value 71 of the detected value 70,.and the height of the dent or the bulge on the surface 40 based on the difference. Therefore, it is possible to eliminate the effect of the overall change in the surface 40 and to calculate the local height of the dent and the bulge.

The light is let to be emitted from the light source that includes the optical-fiber bundle or the light emitting diode and the light that has the distribution of intensity as high as that on the side of the surface 40 is let to be illuminated on the surface 40. This enables to illuminate light that has high luminance, over a wide range.

According to the first embodiment, an optical fiber is disposed such that a center of the optical fiber is at a position towards the side of a surface, away from an optical axis when the light illuminated reaches a CCD sensor upon specular reflection at the flat surface. However, by inserting a variable-transmittance filter that increases the transmittance of the light as high as that of the portion on the side of the surface, between the optical fiber and a diffusion plate, light illuminated that has the distribution of intensity as high as the intensity on the side of the surface may be generated.

Therefore, according to a second embodiment of the present invention, the variable-transmittance filter that increases the transmittance of the light as high as the portion on the side of the surface is inserted between the optical fiber and the diffusion plate and the light illuminated that has the distribution of intensity as high as the intensity on the side of the surface is generated.

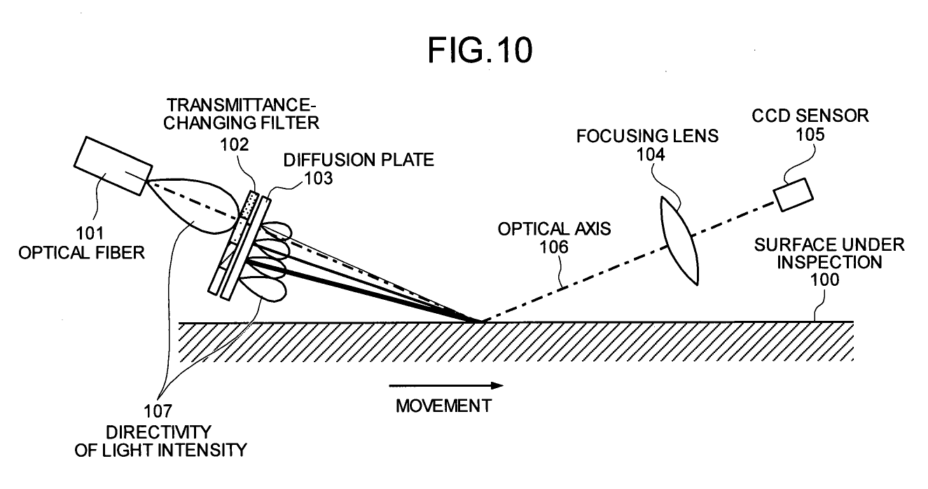

FIG. 10 is a schematic for illustrating a detailed structure of an optical system according to the second embodiment. The optical system includes an optical fiber 101, a diffusion plate 103, and a variable-transmittance filter 102.. The optical fiber 101 illuminates light. The diffusion plate 103 is disposed at a position that is 2 cm to 3 cm away from the optical fiber 101. The variable-transmittance filter 102 increases the transmittance of light as high as that of a portion on a side of a surface 100 under inspection (hereinafter, “surface 100”), and is inserted between the optical fiber 101 and the diffusion plate 103.

By allowing to pass through the variable-transmittance filter 102 light that is emitted from the optical fiber 101, directional characteristic 107 of intensity as high as that of the side of the surface 100, is realized. Due to passing of the light through the diffusion plate 103, light equivalent to that illuminated from a light source having a wide area of illumination is generated.

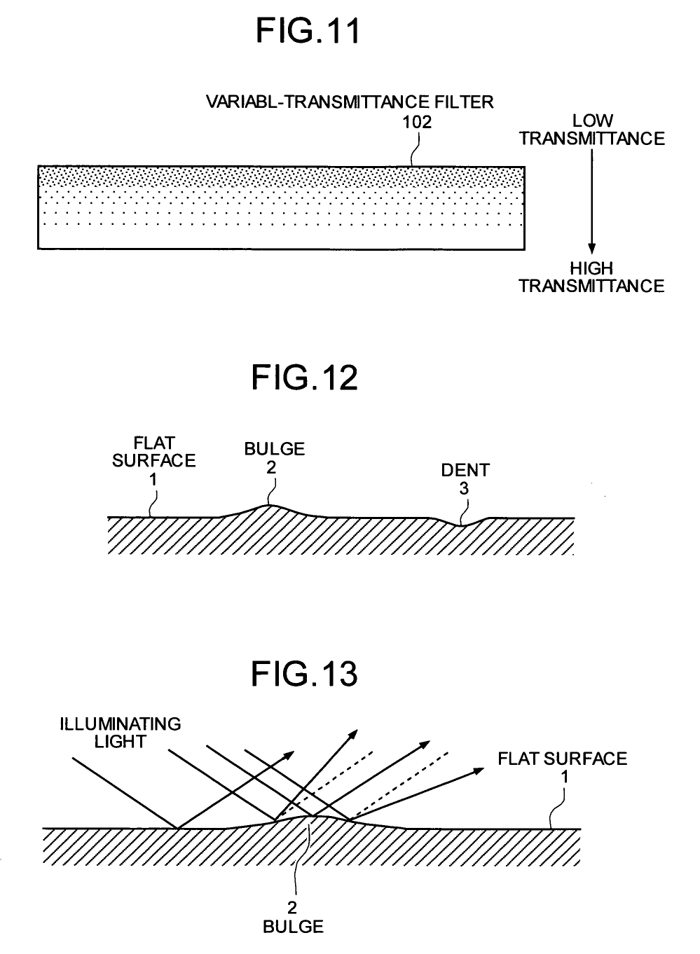

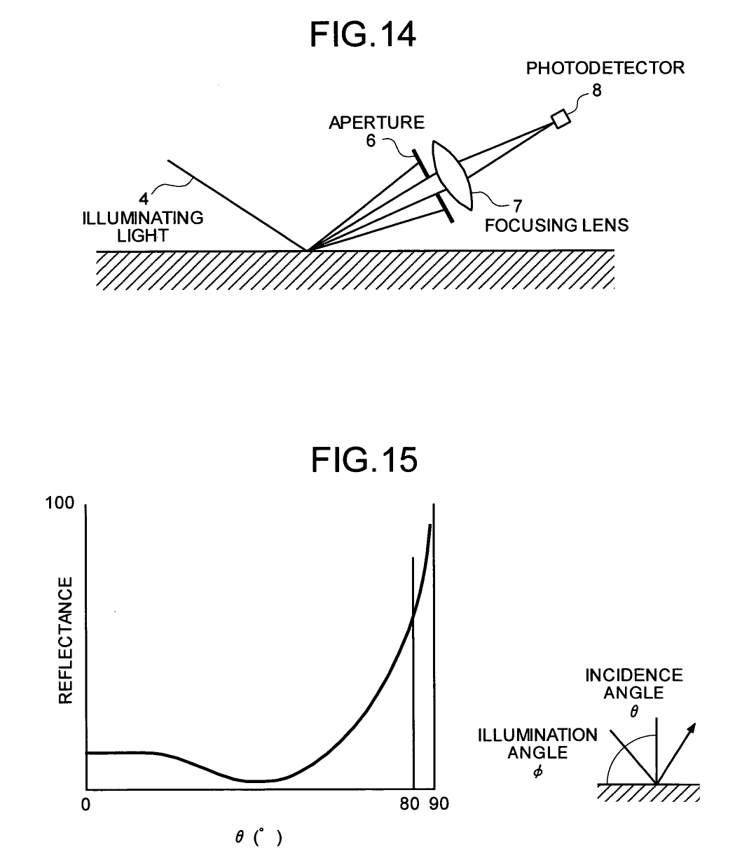

FIG. 11 is a cross section of a variable-transmittance filter 102 shown in FIG. 10. As shown in FIG. 11, the variable-transmittance filter 102 is formed towards a surface that is disposed on the side of the surface 100 from a surface that is disposed on a side opposite to that of the surface 100, so that the transmittance of the light is increased. The variable-transmittance filter 102 can be formed by glass or plastic film.

A focusing lens 104 focuses light that is reflected from the surface 100. A CCD sensor 105 is a line CCD sensor that receives light focused by the focusing lens 104 and detects the intensity of the light received.

According to the second embodiment, the variable-transmittance filter 102 is inserted between the optical fiber 101 and the diffusion plate 103, and the light that has the distribution of intensity as high as that on the side of the surface 100 is generated. However, the light to be illuminated may be generated by combining the methods of generating the light to be illuminated according to the first and the second embodiment.

Thus, according to the second embodiment, by using the optical fiber 101, the diffusion plate 103, and the variable-transmittance filter 102 that increases the transmittance of the light as high as that on the side of the surface 100, the light that has the distribution of intensity as high as that on the side of the surface 100 is let to be illuminated on the surface 100. Therefore, it is possible to generate efficiently the light to be illuminated that has the distribution of intensity as high as that on the side of the surface.

Although the embodiments of the present invention have been described, the appended claims are not to be limited but are to be construed as embodying all modifications and alternative-constructions, which fairly fall within the basic teaching herein set forth.

For example, according to the present embodiments, the optical fiber is used as a light source. However, a light source that includes a plurality of light emitting diodes (LEDs) arranged in a line may be used as a light source.

Furthermore, from among various processes described in the embodiments, some processes or all processes that have been described to be performed automatically can be performed manually or some processes or all processes that have been described to be performed manually can be performed automatically. Apart from this, all processing procedures, control procedures, concrete names, and information that include various data and parameters in the description and diagrams, can be changed voluntarily except in a case mentioned specifically.

All components of the surface inspecting apparatus that are shown in the diagrams are functional conceptions and not necessarily to be structured physically as shown in the diagram. In other words, concrete forms of distributed and integrated structures of the surface inspecting apparatus are not restricted to those shown in the diagrams and some or all of them can be voluntarily distributed and integrated functionally or physically according to various loads and using-conditions.

Each of the processing function performed in the surface inspecting apparatus can be realized partially or wholly by a central processing unit (CPU) or a computer program that is analyzed and run by the CPU, or can be realized as hardware by a wired logic.

According to the present invention, a light that has a distribution of intensity of light as high as an intensity of a side of a surface is let to be illuminated on the surface and an intensity of a reflected light by the surface is detected. Therefore, it is possible to change the intensity of the reflected light according to the dents and bulges on the surface and to detect in detail the defect on the surface.

The light is let to be radiated on the surface such that an angle of an optical axis of the light illuminated with surface is in a range of 5 degrees to 20 degrees. Therefore, it is possible to change further the intensity of the reflected light according to the dents and bulges on the surface and to detect in detail the defect on the surface.

A center of a light source is disposed in a position away from the optical axis of the light towards the side of the surface when the light is detected upon a specular reflection on a flat surface, and by using an optical system in which a light diffusing plate is disposed in a position away from the light source so that the light emitted from the light source passes through it, the light that has the distribution of intensity of light as high as the intensity of the side of the surface is let to be illuminated on the surface. Therefore, an illuminating light that has the distribution of intensity of light as high as the side of the surface can be generated efficiently.

Moreover, according to the present invention, a distance between the light source and the light diffusing plate is let to be in a range of 2 cm to 3 cm. This enables the light emitted from the light source to be diffused appropriately.

By using a filter that increases transmittance of light up to a portion of the side of the surface, the light that has the distribution of intensity of light as high as the intensity of the side of the surface is let to be illuminated on the surface. Therefore, the illuminating light that has the distribution of intensity of light as high as the side of the surface can be generated efficiently.

A height of the dent or the bulge on the surface is calculated based on a relation of the intensity detected of the reflected light and an angle of the reflected light with the surface. Therefore, by calculating the height, the defect on the surface can be detected in detail.

According to the present invention, a difference between the angle of the reflected light with the surface and an average value of the angle with the surface is calculated and the height of the dent or the bulge on the surface is calculated based on this difference. This enables to eliminate the effect of a change in the overall surface and to calculate locally the height of the dent and the bulge.

Light is let to be emitted from a light source that includes an optical-fiber bundle or a light emitting diode and the light that has the distribution of intensity of light as high as the intensity of the side of the surface is let to be illuminated on the surface. This enables to illuminate light having high luminance.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A surface inspecting apparatus that inspects a surface of a material based on an intensity of a reflected light from the surface, the surface inspecting apparatus comprising:
an illuminating unit that illuminates a light on the surface; and
a detecting unit that detects the intensity of the reflected light from the surface, wherein
the light has an intensity distribution in which an intensity of the light is higher approaching the surface.

2. The surface inspecting apparatus according to claim 1, wherein a first angle formed by an optical axis of the light and the surface is in a range of 5 degrees to 20 degrees.

3. The surface inspecting apparatus according to claim 1, further comprising an optical system in which a center of a light source is disposed at a position deviated towards the surface away from an optical axis of the light that is formed when a light is detected upon a specular reflection at a flat surface, and a light diffusing plate is disposed away from the light source such that a light emitted from the light source passes through the light diffusing plate, wherein
the illuminating unit illuminates the light having the intensity distribution on the surface using the optical system.

4. The surface inspecting apparatus according to claim 3, wherein a distance between the light source and the light diffusing plate is in a range of 2 centimeters to 3 centimeters.

5. The surface inspecting apparatus according to claim 1, further comprising a filter that has a higher transmittance approaching the surface, wherein
the illuminating unit illuminates the light having the intensity distribution on the surface using the filter.

6. The surface inspecting apparatus according to claim 1, further comprising a height calculating unit that calculates a height of a dent or a bulge on the surface based on a relationship between the intensity of the reflected light and a second angle formed by an optical axis of the reflected light and the surface.

7. The surface inspecting apparatus according to claim 6, wherein the height calculating unit calculates a difference between the second angle and an average value of the second angle, and calculates the height based on the difference calculated.

8. The surface inspecting apparatus according to claim 1, further comprising a light source that includes an optical-fiber bundle or a light emitting diode to emit the light, wherein
the illuminating unit illuminates the light having the intensity distribution on the surface using the light source.

9. A method of inspecting a surface of a material based on an intensity of a reflected light from the surface, the method comprising:
illuminating a light on the surface; and
detecting the intensity of the reflected light from the surface, wherein
the light has an intensity distribution in which an intensity of the light is higher approaching the surface.

10. The method according to claim 9, wherein a first angle formed by an optical axis of the light and the surface is in a range of 5 degrees to 20 degrees.

11. The method according to claim 9, wherein the illuminating includes illuminating the light having the intensity distribution on the surface using an optical system in which a center of a light source is disposed at a position deviated towards the surface away from an optical axis of the light that is formed when a light is detected upon a specular reflection at a flat surface, and a light diffusing plate is disposed away from the light source such that a light emitted from the light source passes through the light diffusing plate.

12. The method according to claim 11, wherein a distance between the light source and the light diffusing plate is in a range of 2 centimeters to 3 centimeters.

13. The method according to claim 9, wherein the illuminating includes illuminating the light having the intensity distribution on the surface using a filter that has a higher transmittance approaching the surface.

14. The method according to claim 9, further comprising calculating a height of a dent or a bulge on the surface based on a relationship between the intensity of the reflected light and a second angle formed by an optical axis of the reflected light and the surface.

15. The method according to claim 14, wherein the calculating includes
calculating a difference between the second angle and an average value of the second angle; and
calculating the height based on the difference calculated.

16. The method according to claim 9, wherein the illuminating includes illuminating the light having the intensity distribution on the surface using a light source that includes an optical-fiber bundle or a light emitting diode to emit the light.
